(19) United States
(12) Patent Application Publication
(10) Pub. No.: US 2005/0121370 A1
(43) Pub. Date: Jun. 9, 2005

(54) Method and apparatus for improving froth flotation

(75) Inventors: Graeme John Jameson, New South Wales (AU); Emmanuel Salvador Viana, Queensland (AU); Zeljka Pokrajcic, Queensland (AU); Stephen Smith, Queensland (AU); Gregory J Harbort, Queensland (AU)

Correspondence Address: STEVENS DAVIS MILLER & MOSHER, LLP, 1615 L STREET, NW, SUITE 850, WASHINGTON, DC, 20036, US

(73) Assignee: M.I.M. Holdings Limited, Brisbane (AU)

(21) Appl. No.: 10/498,877

(22) PCT Filed: Dec. 17, 2002
(86) PCT No.: PCT/AU02/01701

(30) Foreign Application Priority Data
Dec. 17, 2001 (AU) PR 94995

(51) Int. Cl. B03D 1/14

(52) U.S. Cl. 209/164

(57) ABSTRACT

An apparatus for supplying a reagent to a froth flotation cell. The flotation cell is fed by a flotation gas feed line. A predetermined volume is in fluid communication with said flotation gas feed line. The volume has a gas inlet on an upstream side, a gas outlet on a downstream side. An atomiser is positioned intermediate the inlet and outlet to atomise the reagent into the predetermined volume. The atomised reagent is then entrained with the flotation gas entering said cell.

### TECHNICAL FIELD

The present invention relates to froth flotation and in particular methods and apparatus for maximising flotation recovery and yield while optimising reagent usage.

### BACKGROUND ART

Separation of fine coal from ash by flotation is based on the difference in wettability (or hydrophobicity) between the coal and ash. Coal is naturally hydrophobic (fear of water), while ash is naturally hydrophilic (love for water). In flotation, air is introduced into the coal-ash slurry. The hydrophobic coal particles cling to the air bubbles and rise with them to the top of the flotation cell where they are collected as concentrate, whereas the hydrophilic ash particles sink to the bottom of the cell and report to tailings. Thus the fine coal and ash particles are separated.

If no frother was added to the flotation process the air bubbles would not be stable, would tend to coalesce and break up and any coal particles adhering to them would sink back into the pulp. By the addition of certain surface-active organic compounds, called frothers, a stable froth is formed on the surface which facilitates transfer of the floated coal particles from the cell to the collection launders.

Current practice in all flotation applications is to add the frother to the liquid (slurry) phase and allow it to diffuse from the slurry to the air liquid interface. This method of addition, however, can be inefficient due to inadequate frother dispersion within the slurry and the requirement for frother migration within the liquid phase. In current coal flotation plants, frother quantities in the order of 5 to 20 ppm (parts per million) are added (ie, 5 to 20 grams of frother into 1 million grams of fresh coal slurry). At such low dosage rates it is difficult to achieve uniform dispersion of the frother within the slurry. Also important is that the frother is required to act on the air-liquid interface. Frother added to the slurry is therefore required to migrate from the liquid phase to the air-liquid interface when air comes into contact with slurry.

Frother is a very important operating parameter in Jameson Cells and has a major impact on fine coal yields from flotation. The Jameson Cell and its operation is discussed in detail in Australian Patent No 677452 (which is incorporated herein by reference). In addition to creating a stable frother layer on the cell surface, frother significantly improves the air vacuum and hence air flow rate. Higher airflow rates generate finer and more numerous air bubbles and higher bubble rise velocities. Finer and larger quantities of air bubbles mean there is more air surface area for the fine coal particles to be attached. This coupled with higher air bubble rise velocities, results in much higher coal yields from flotation.

If frother is added to the liquid phase, as per current practice, then to achieve optimum mass yields from the flotation circuit 20 ppm of frother is recommended. However, in reality most sites are only able to add 5 to 10 ppm. This is a consequence of the design of coal preparation plants and higher levels of frother are not achievable without expending considerable capital to change the plant design, in particular the water balance. At most coal preparation plants the tailings from the flotation circuit reports to the thickener. The overflow from the thickener is process water that is recirculated back to the plant, including the coarse coal circuit. When frother levels of greater than 5 to 10 ppm are added to the flotation circuit, due to the inefficiencies of adding frother to the liquid phase, residual frother reports to the tailings and hence process water. This creates major operational upsets in the coarse coal circuit (“frothing out the plant”) and therefore frother dosages have to be limited.

In addition, various reagents are used to assist in recovery of other minerals such as valuable sulphide or secondary minerals. There is a need to increase the effectiveness of various reagents used in froth flotation such as collectors and frothers and thus improve the recovery of valuable minerals using known reagents.

Any discussion of the prior art throughout the specification should in no way be considered as an admission that such prior art is widely known or forms part of common general knowledge in the field.

It is an object of the present invention to overcome or ameliorate at least one of the disadvantages of the prior art, or to provide a useful alternative.

### DISCLOSURE OF INVENTION

In a first aspect, the present invention provides an apparatus for supplying a reagent to a froth flotation cell, said apparatus comprising a flotation gas feed line and a predetermined volume in fluid communication with said flotation gas feed line, said volume having a gas inlet on an upstream side, a gas outlet on a downstream side and an atomiser positioned intermediate the inlet and outlet, said atomiser being adapted to atomise said reagent such that said atomised reagent is entrained with flotation gas entering said cell.

The predetermined volume may be formed within the flotation gas feed line or, alternatively, the volume may take the form of a chamber in fluid communication with the flotation line. This second option is particularly suitable for retrofitting of the apparatus to flotation cells, which of course, already have a flotation gas feed line.

If a froth flotation cell was being constructed with the aforementioned apparatus from scratch, for example, the atomiser of course may be positioned anywhere on the flotation gas feed line. A particularly suitable embodiment for use with Jameson Cells is the incorporation of the atomiser in the air distributor which feeds air to the various downcomers in the Jameson Cell.

The apparatus is suitable for use on a flotation gas feed line which is sub-atmospheric, for instance, where the cell is a Jameson Cell, or where the flotation gas feed line is at or greater than atmospheric pressure.

Where the atomiser is positioned within the chamber on the gas feed line, it is preferable that the atomiser is positioned adjacent the inlet of that chamber and spaced a sufficient distance from the outlet to minimise impact and condensation of the atomised reagent on the chamber wall.

To further reduce condensation of the reagent, the chamber and/or flotation gas feed line between the volume and the cell may be thermally insulated.

Generally, the dimensions of the chamber will depend upon a number of factors including flotation slurry feed rates, flotation gas feed rates, the type and amount of reagent to be atomised, etc. In one embodiment, the dimensions of the chamber are calculated by determining an atomisation area from said atomiser, ie the area covered by the spray emanating from the atomiser. An appropriate clearance, eg 200 mm may then be added to this figure to avoid direct impact of the reagent mist emanating from the atomiser onto the walls of the chamber.

In most installations it is envisaged that each flotation cell would have a defined volume/atomiser in the flotation gas line.

It will be understood by persons skilled in the art that the atomiser can be any suitable apparatus for atomising a liquid reagent such as nozzles, jet sprays, ultrasonic generators, etc.

In a second broad aspect, the present invention provides a method of supplying a reagent to a froth flotation cell comprising defining on a flotation gas inlet side to the cell, a predetermined volume having a gas inlet and a gas outlet, positioning within said volume an atomiser to produce an atomised reagent within said volume, and passing flotation gas through said volume such that said atomised reagent is entrained with a flotation gas entering the flotation cell.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### BRIEF DESCRIPTION OF THE DRAWINGS

The present invention will now be described by way of example only, with reference to the accompanying embodiments exemplified in the drawings as follows:

FIG. 1 is a front elevational view of a chamber to be used in conjunction with a flotation cell in accordance with a first embodiment of the present invention,

FIG. 2 is an end elevational view of the interior of the chamber of FIG. 1, and

FIG. 3 is a schematic elevational view of the chamber in use with a Jameson Cell.

FIGS. 4 to 6 are graphs of test results for % ash in tails, % yield and % combustibles recovery respectively.

### BEST MODE FOR CARRYING OUT THE INVENTION

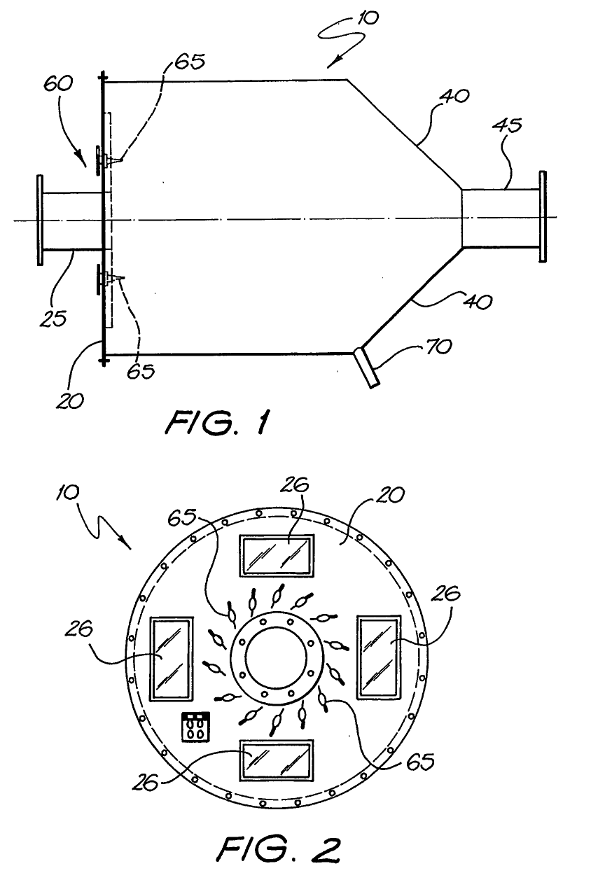

In the embodiments shown in FIGS. 1 to 3, the predetermined volume in fluid communication with the flotation gas feed line is provided by a chamber 10. It will be understood by persons skilled in the art, however, that a separate chamber 10 is not required and the invention may be embodied by any predetermined volume formed on or in fluid communication with flotation gas feed line 100.

In particular, the chamber 10 is shown on the flotation gas feed line 100 of Jameson Cell. The flotation gas enters the cell through flotation gas feed line 100 into air distributor 150 and from the distributor via connector 160 to a downcomer 170.

The flotation slurry is fed to the downcomer 100 by means of slurry distributor 200 and slurry feed line 210.

The embodiment shown in FIGS. 1 to 3 wherein the predetermined volume as provided by chamber 10 is particularly suitable for retrofit applications. As will be clear to persons skilled in the art, to include chamber 10 on a flotation gas feed line is a reasonably simple process.

For a purpose built facility, however, the predetermined volume for the atomiser 60 can be positioned anywhere on the flotation gas feed line. In one particular embodiment it is envisaged that the atomising means 60 may be provided in the air distributor 150. In such an instance, the air distributor has the dual roles of distributing flotation gas to the downcomers and as the predetermined volume for atomisation of the flotation reagent.

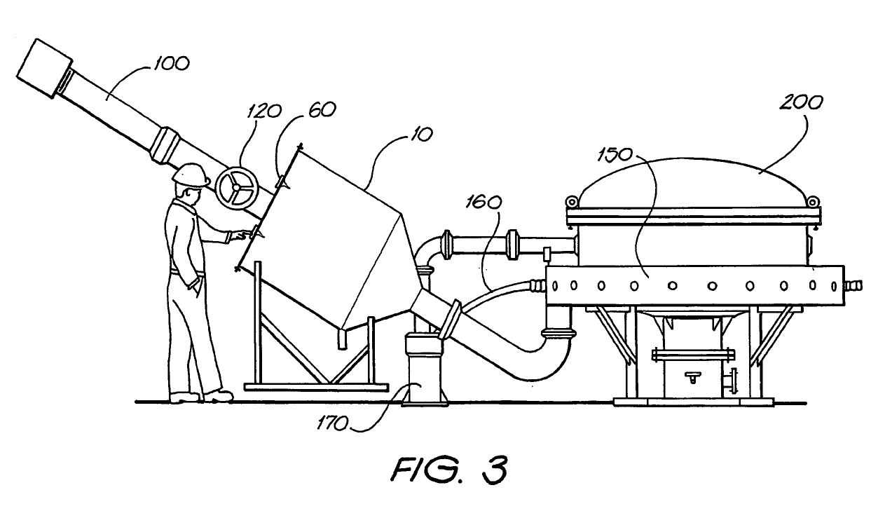

Referring now to FIGS. 1 and 2, the chamber 10 comprises an upstream wall 20, downstream wall 40 on which are positioned inlet and outlet pipe connectors 25 and 45 which, as discussed below, are adapted to be connected to a flotation gas feed pipe providing gas to the flotation cell.

On upstream wall 20 is positioned atomising means 60, in this case, a plurality of nozzles 65. The upstream wall 20 may be provided with a series of viewing windows 26 to view operation of the atomising means 60 as will be discussed below. A drainage hole 70 may also be provided to allow for removal of condensed reagent as will be discussed below.

As can be seen in FIGS. 1 and 2, the atomising means 60 is provided by an annular array of nozzles 65 around inlet 25. While this is not essential to the invention, it has been found that such an array of nozzles provides for good atomisation and entrainment of the reagent mist with the flotation gas entering the chamber.

In this embodiment, inlet 25 and outlet 45 are essentially coaxial with the chamber 20. While not essential, this is also preferred since it permits for rapid flow of inlet air through the chamber with the entrained reagent. As will be clear to persons skilled in the art, any offset of inlet 25 to outlet 45 may interrupt the smooth flow through the chamber and create unnecessary turbulence or eddies therein reducing entrainment of the reagent mist with the flotation gas entering the cell and promote condensation on the chamber walls.

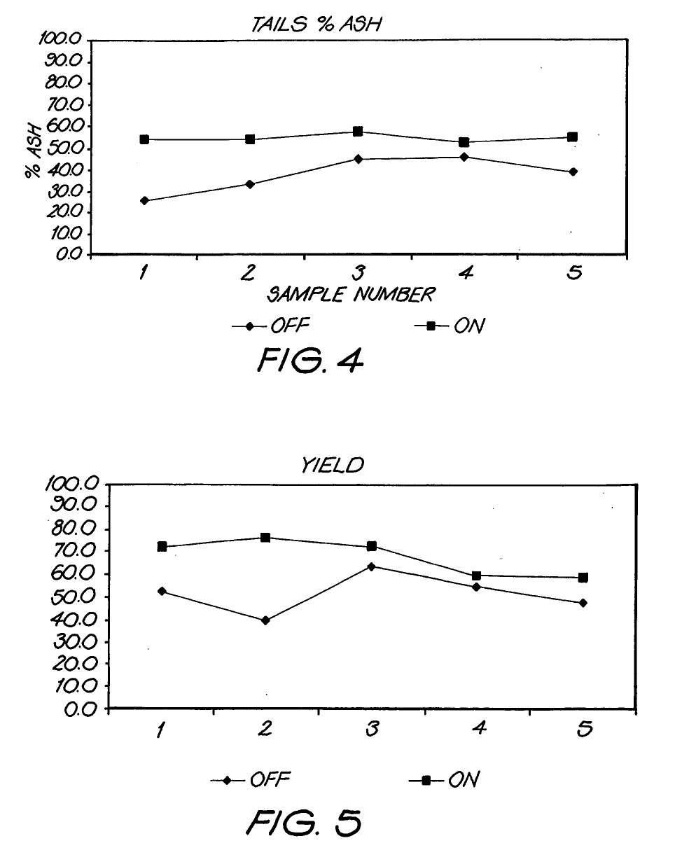

Turning now to FIG. 3, the operation of the chamber will now be discussed.

FIG. 3 shows the chamber 10 positioned on the gas inlet line 100 feeding a Jameson Cell 200. The apparatus is suitable for other flotation apparatus but for the sake of simplicity will be discussed here with reference to a Jameson Cell.

The gas inlet line 100 contains a valve 120 which constricts gas line 100 thereby controlling the partial vacuum in the Jameson Cell, controlling the speed and quantity of gas, in this case air, which enters the Jameson Cell 200. Details of the Jameson Cell can be found in a number of patents/applications including Australian Patent No 677542 (which is incorporated herein by reference).

In use, atomising means 60 is connected to a particular reagent. The embodiment described will relate to atomised addition of frother, however, it will be understood that other reagents can be atomised in a similar fashion.

The nozzles 65 are supplied with compressed gas such as air and frother. The frother is pumped to the nozzle at a metered rate and compressed air is supplied under pressure. Inside the nozzle, the compressed air impacts with the frother breaking it up into small droplets and forcing it out of the nozzle as an aerosol, spray or mist.

The nozzles provide a spray of reagent which is entrained with the air passing through the chamber 10 into the cell. In the embodiment shown, the nozzle spray is essentially parallel with the air stream through the chamber. In other embodiments, the nozzles may be adjustable such that the spray from the nozzles converge, diverge or extend substantially parallel. As mentioned above, it is preferred that turbulence and residence time in the chamber is reduced by providing a fast smooth entry and exit into and out of the chamber. In this regard it will be noted that exit wall 40 is tapered to provide such a smooth exit. The Applicant has found that at conventional frother dosages, the use of the inventive method and apparatus substantially improves yield and recovery in the flotation cell.

The four windows 26 mounted on wall 20 allow for visual inspection of the mist created by the nozzles. This permits monitoring of the spray pattern as well as noting changes in reagent character or consumption and help identify blocked or non-operational nozzles. It also allows for experimentation with different spray patterns, nozzle air pressures etc to determine their effect on nozzle performance.

Preferably, wall 20 is flanged such that it allows for easy removal and access to the nozzles either as a group or individually.

One of the major difficulties with atomising of reagents for subsequent feeding to the flotation cell is condensation of the spray or mist, either on the walls of the chamber or in the gas line 100 downstream of chamber 10.

There are a number of factors which influence the condensation rate including the size of the droplets being issued from the nozzles, contact of droplets with surfaces, residence time in the chamber and contact with surfaces of different temperatures.

Unlike many conventional aerosol systems, which require heating of the aerosol fluid, the nozzles or the aerosol chamber, the present apparatus and method provides excellent control of condensation of the aerosol without the need for such expensive or complex heating systems.

In this regard, the present invention provides for modification of several operational parameters to reduce condensation of the reagent spray or mist. Firstly, it has been found that the nozzles operate best with relatively low reagent flow, relative to the compressed gas being fed to then nozzle. It appears that low flow of the liquid reagent together with high air pressure results in a mist of finer droplet size.

Another parameter is the distance between walls 20 and 40. As will be clear to persons skilled in the art, if wall 40 is placed too close to wall 20, the droplets issuing from nozzle 65 will impact wall 40 and condense thereon. Accordingly, the distance between walls 20 and 40 should be adjusted to ensure minimal condensation arising from contact of the mist or spray on wall 40.

Another step to reduce condensation is to maximise airflow through the chamber. This is performed in the embodiment shown by incorporating the chamber as a feature of the air inlet line on the Jameson Cell, in other words, all air entering the Jameson Cell has to pass through the chamber, ie maximum air flow and air speed.

There are of course significant advantages, apart from reduced condensation, arising from passing all inlet flotation gas through the chamber. These include better mixing, greater distribution of the frother in the pulp and reduction in expenses since additional piping and/or pressurising systems are not required to force the mist into the cell.

Another way of reducing condensation is to insulate the chamber and downstream pipe work to minimise temperature differences between conditions within the chamber and the chamber wall. While it is not yet proved, the applicant believes one of two things will happen to larger droplets within the chamber. They will either be impacted by air passing through the chamber and reduced inside or they will contact the surface, condense and be collected for recycling via drainage port 70. Smaller droplets will be entrained in the inlet air through the air distributor to the Jameson Cell downcomer.

It will be appreciated that such an arrangement is also extremely flexible and less subject to environmental influences than the aforementioned conventional systems.

The Applicants have indeed found that the apparatus and method operates successfully in quite different environments e.g. high temperature or humidity as well as low temperature or dry environments. Such flexibility appears absent from prior art devices which rely on extensive temperature control systems to remain within suitable operational parameters.

### EXAMPLE 1

Test work has been conducted at Sunwater Laboratories, Rocklea, Brisbane using two chambers of different dimensions with 3 nozzles. The results of this testing is discussed below.

Two chambers were tested with various nozzle flows and airflow. The nozzles were supplied with MIBC frother. Flow through the nozzle depended upon the MIBC pump dosage rate. The compressed air requirement for 3 nozzles at 300 kPa was 5 m³/hour. The compressed air to the nozzles was dry and filtered so as to reduce blockage of the nozzles. The results are shown in Table 1.

TABLE 1
Sunwater Laboratories Test Data
No. DC's = 24 m³ per
Pulp flow = 70 DC
Air/Pulp Ratio = 0.8
No. Nozzles = 14

| | | | | | | | MIBC | | MIBC |
|---|---|---|---|---|---|---|---|---|---|
| | | | | | Air Flow | | (not | MIBC | total Flow |
| | | Air | | MIBC | Thru | | incl. | (incl. | (incl. |
| Chamber | Nozzle | Pressure | Pump | Flow | Chamber | Condensation | losses) | losses) | losses) |
| Size | Size | KPa | Speed % | 1/hr | m³/hr | Losses % | ppm | ppm | 1/hr |
| 800 × 800 | 1650 | 294 | 25 | 2.05 | 71 | 7% | 7 | 7 | 9.6 |
| 800 × 800 | 1650 | 294 | 50 | 4.09 | 72 | 22% | 14 | 11 | 19.1 |
| 800 × 800 | 1650 | 294 | 100 | 8.69 | 71 | 33% | 30 | 20 | 40.6 |
| 400 × 400 | 1650 | 294 | 25 | 2.03 | 76 | 6% | 7 | 7 | 9.5 |
| 400 × 400 | 1650 | 294 | 50 | 4.13 | 73 | 18% | 14 | 12 | 19.3 |
| 400 × 400 | 1650 | 294 | 100 | 8.83 | 74 | 39% | 31 | 19 | 41.2 |

As can be seen from Table 1, with both chamber sizes, lower flows to the nozzles resulted in reduced condensation of the MIBC frother mist and therefore reduced wastage of the MIBC frother. In this regard, it is believed that a significant advantage arises from the present invention in that the reagent, in this case the froth acting agent, is provided directly into the column of froth formed in the Jameson Cell downcomer rather than the pulp. This clearly has a significant advantage over the prior art in that the frother is provided to the most efficient location for its use, ie the point at which froth generation takes place.

In the example where pump speed was 100%, ie maximum flow to the nozzles at least a third of the frother was lost to condensation. This condensed frother may be retrieved, however, via drainage line 70 and recycled back to the system. Further, it is preferred that air distributor 150 have a sloping floor which allows any reagent/frother condensed downstream of chamber to drain to a single point for recycling back to the Jameson Cell.

### EXAMPLE 2

This example was carried out at Oaky Creek J5000/24 Coal Prep Plant, a comparison was conducted on a Jameson Cell using the aforementioned method and apparatus to atomise the frother as compared with conventional addition of frother to the pulp.

Table 2 below shows the results of percentage ash in the tails, percentage yield and percentage combustibles recovered from the coal undergoing flotation.

TABLE 2
Comparison of Chamber/Atomiser with Conventional Frother Dosage

| | | |
|---|---|---|
| Tails | Yield | Comb. Rec. |

| OFF | ON | OFF | ON | OFF | ON |
|---|---|---|---|---|---|
| 25.6 | 54.2 | 53.1 | 72.4 | 59.2 | 84.1 |
| 33.5 | 54.4 | 39.7 | 76.5 | 45.5 | 86.9 |
| 45.0 | 57.9 | 63.3 | 72.4 | 74.5 | 85.2 |
| 45.9 | 52.7 | 54.8 | 59.3 | 67.8 | 74.2 |
| 38.8 | 55.0 | 46.9 | 58.6 | 57.5 | 74.5 |

Note,
ON = Use of Chamber/Atomiser
OFF = Conventional Frother Addition

The various samples were dosed with 5 ppm frother (MIBC), slurry rate of 1560 m³/hr

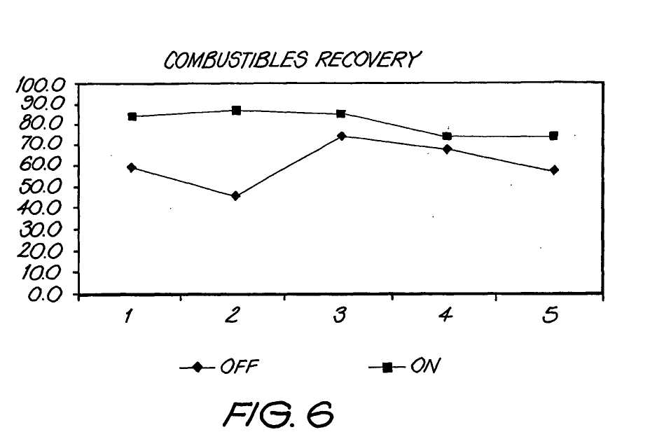

In every case, use of the chamber 10 to atomise and add frother provided a substantial increase over conventional mechanisms. A graphical representation of the results of Table 2 are shown in FIGS. 4 to 6.

As discussed above, while the embodiment shown is in regard to a Jameson Cell, which uses an air inlet line below atmospheric pressure, it will be understood that it is also suitable for use with other flotation gases and flotation cells with pressurised flotation gas inlets.

Testing conducted by the Applicants has shown remarkable results to date. For instance, current MIBC consumption at the Oaky Creek site is less than 6 ppm. A concentration above this limit would adversely affect the remainder of the circuit. However, 6 ppm MIBC is well below the recommended 20 ppm for optimum Jameson Cell operation when MIBC is added as a liquid.

Test work has indicated that aerosol/mist addition of MIBC may reduce the quantity of MIBC required for optimum Jameson Cell operation by at least 75%. Hence, MIBC consumption using the inventive method and apparatus will range from between 4 to 7 ppm. At these levels and as evidenced by the attached data, an increased coal yield of at least 5% will clearly provide substantial additional revenue in terms of recovered product, but also substantial savings in terms of MIBC consumption.

In addition, using the inventive method and apparatus increases efficiency of the Jameson cell at conventional dosage levels, eg around 5-10 ppm

It will be understood by persons skilled in the art that the above mentioned described method and apparatus may be embodied in other forms without departing from the spirit or scope of the present invention.

1. An apparatus for supplying a reagent to a froth flotation cell, said apparatus comprising a flotation gas feed line and a predetermined volume in fluid communication with said flotation gas feed line, said volume having a gas inlet on an upstream side, a gas outlet on a downstream side and an atomiser positioned intermediate the inlet and outlet, said atomiser being adapted to atomise said reagent into said predetermined volume such that said atomised reagent is entrained with flotation gas entering said cell.

2. An apparatus as claimed in claim 1, wherein the volume is formed within the flotation gas inlet line.

3. An apparatus as claimed in claim 1, wherein the volume is formed by a chamber in fluid communication on the flotation gas feed line.

4. An apparatus as claimed in claim 1, wherein said flotation gas feed line is sub-atmospheric.

5. An apparatus as claimed in claim 1, wherein the flotation cell is a Jameson Cell.

6. An apparatus as claimed in claim 5, wherein said atomiser is located adjacent an air distributor in the downcomer of the Jameson Cell.

7. An apparatus as claimed in claim 1, wherein said flotation gas feed line is at or greater than atmospheric pressure.

8. An apparatus as claimed in claim 3, wherein the atomiser is positioned adjacent the inlet of the chamber.

9. An apparatus as claimed in claim 3, wherein the atomiser is spaced a sufficient distance from the outlet of the chamber to minimise impact and condensation of the atomised reagent on the chamber wall.

10. An apparatus as claimed in claim 1, wherein the volume and/or flotation gas feed line between the volume and cell are thermally insulated.

11. An apparatus as claimed in claim 1 wherein the atomiser is adapted to atomise a frother into said predetermined volume.

12. A method of supplying a reagent to a froth flotation cell comprising defining on a flotation gas inlet side to the cell, a predetermined volume having a gas inlet and a gas outlet and positioning within said volume an atomiser to produce an atomised reagent within said volume, and passing flotation gas through said volume such that said atomised reagent is entrained with a flotation gas entering the flotation cell.

13. A method as claimed in claim 12, wherein the predetermined volume is provided in the flotation gas inlet line.

14. A method as claimed in claim 12, wherein the predetermined volume is provided by a chamber located on the flotation gas feed line, the atomiser producing an atomised reagent into said chamber for entrainment with a flotation gas passing therethrough.

15. A method as claimed in claim 12, wherein the flotation gas feed line is run at sub-atmospheric pressure.

16. A method as claimed in claim 12, wherein the flotation gas feed line is run at or greater than atmospheric pressure.

17. A method as claimed in claim 12, wherein the predetermined volume is defined by measuring a projected atomisation volume of the atomiser, adding an appropriate clearance thereto and ensuring that said predetermined volume is equal to or greater than the resultant dimensions.

18. A method as claimed in claim 1, wherein the reagent is a frother.

19. An apparatus for supplying a reagent to a froth flotation cell substantially as herein described with reference to any one of the embodiments of the invention illustrated in the accompanying drawings and/or examples.

20. A method for supplying a reagent to a froth flotation cell substantially as herein described with reference to any one of the embodiments of the invention illustrated in the accompanying drawings and/or examples.
